(19) United States
(12) Patent Application Publication
(10) Pub. No.: US 2009/0108813 A1
(43) Pub. Date: Apr. 30, 2009

(54) Portable electronic device with chargeable circuit

(76) Inventors: Yi-Hung Shen, Taipei City (TW); Chi-Ming Lan, Taipei City (TW)

Correspondence Address: SINORICA, LLC, 528 FALLSGROVE DRIVE, ROCKVILLE, MD, 20850, US

(21) Appl. No.: 12/010,095

(22) Filed: Jan. 18, 2008

(30) Foreign Application Priority Data
Apr. 17, 2007 (TW) 096113434

(51) Int. Cl. H02J 7/00

(52) U.S. Cl. 320/155

(57) ABSTRACT

The present invention relates to a portable electronic device with chargeable circuit, which comprises: a micro controller; a timer unit coupled to the micro controller; an input button coupled to the micro controller; a voltage converter coupled to the micro controller and input button; and an output interface coupled to the output of the voltage converter. Whereby, when the input button is pressed, the voltage converter will be activated and then supply power to the microcontroller. Afterwards, the microcontroller will activate the timer unit and the voltage controller for outputting power to the output interface in order to charge an electronic product.

### BACKGROUND OF THE INVENTION

1. Field of the Invention

The present invention relates to a portable electronic device with chargeable circuit, and more particularly, to a portable electronic device with chargeable circuit which can be used to charge an external 3C (Communications, Consumer Electronics and Computing) product without the need to turn on the computer and also comprises a timer unit to avoid overcharging.

2. Description of the Related Art

The battery of the current notebook (a.k.a. laptop) computer is connected to the notebook computer through a connector. The battery can only be used and charged by the notebook computer, but it cannot supply power to other external 3C (Communications, Consumer Electronics and Computing) products.

Along with the prevalence of the USB interface, most 3C electronic products are equipped with a USB connector, which can be connected to the USB port of the notebook computer to charge the 3C electronic product. Accordingly, it would be much more convenient without the need of carrying different types of chargers when the user goes out.

For current notebook computers, the 3C electronic product can be charged by the notebook computer through the USB port only when the notebook computer is turned on. A notebook computer with mobile chargeable circuit had been disclosed in R.O.C. Patent No. M244639 “A notebook computer with mobile chargeable circuit” applied on Jun. 25, 2003. In the aforementioned application, when the user desires to charge the external 3C electronic product through the notebook computer, the notebook computer needs to be turned on first, which is inconvenient to the user and also wastes battery power.

Accordingly, it is a requirement to design a new portable electronic device with chargeable circuit to overcome the disadvantages mentioned above.

### SUMMARY OF THE INVENTION

Therefore, it is an objective of the present invention to provide a portable electronic device with chargeable circuit, which is capable of supplying power to charge the external 3C electronic product while the computer system is turned off.

It is another objective of the present invention to provide a portable electronic device with chargeable circuit, which comprises a timer unit to prevent the 3C electronic product from being overcharged by the portable electronic device.

To achieve the foregoing objectives, the present invention provides a portable electronic device with chargeable circuit, which comprises: a micro controller; a timer unit coupled to the micro controller; an input button coupled to the micro controller; a voltage converter coupled to the micro controller and input button; and an output interface coupled to the output of the voltage converter. Whereby, when the input button is pressed, the voltage converter will be activated and then supply power to the microcontroller. Afterwards, the microcontroller will activate the timer unit and the voltage controller for outputting power to the output interface in order to charge an electronic product.

### BRIEF DESCRIPTION OF THE DRAWINGS

The accompanying drawings are included to provide a further understanding of the invention, and are incorporated in and constitute a portion of this specification. The drawings illustrate embodiments of the invention, and together with the description, serve to explain the principles of the invention.

FIG. 1 schematically shows a portable electronic device with chargeable circuit according to a preferred embodiment of the present invention.

FIG. 2 is a schematic diagram showing a 3C electronic product being charged by the portable electronic device with chargeable circuit according to a preferred embodiment of the present invention while the portable electronic device is turned off.

### DETAILED DESCRIPTION OF THE PREFERRED EMBODIMENTS

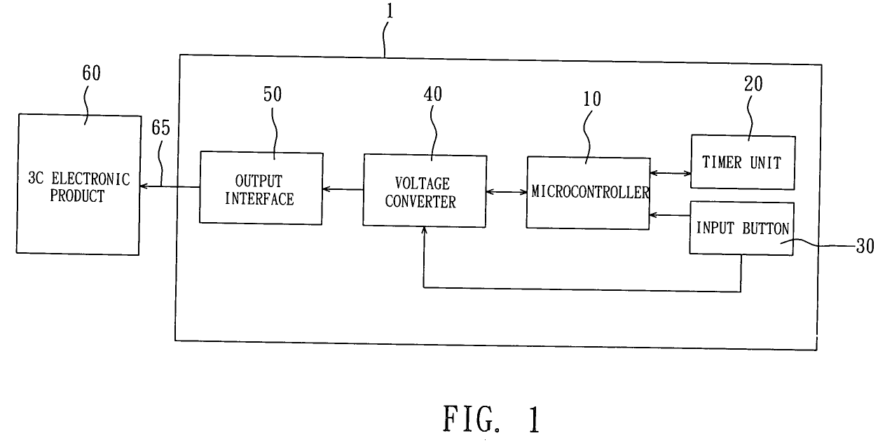

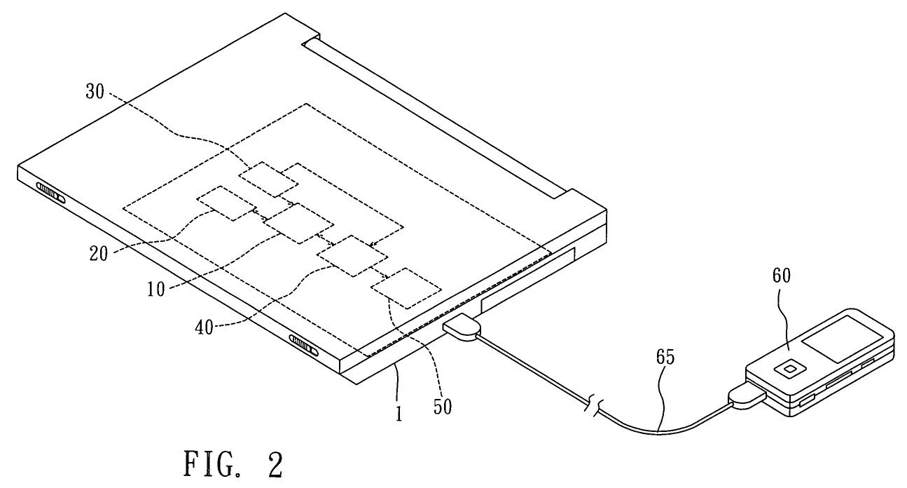

Refer to FIGS. 1 and 2, wherein FIG. 1 schematically shows a portable electronic device with chargeable circuit according to a preferred embodiment of the present invention, and FIG. 2 is a schematic diagram showing a 3C electronic product being charged by the portable electronic device with chargeable circuit according to a preferred embodiment of the present invention while the portable electronic device is turned off. As shown in the drawings, the portable electronic device with chargeable circuit of the present invention is for example, but not limited to be a notebook computer, which comprises: a microcontroller 10; a timer unit 20; an input button 30; a voltage converter 40; and an output interface 50.

Wherein, the microcontroller 10 is for example, but not limited to be an Embedded Controller (EC), which controls the portable electronic device 1 to charge a 3C electronic product 60. The 3C electronic product 60 is for example, but not limited to be a mobile phone, a hand-held game console or a Personal Digital Assistant (PDA).

The timer unit 20 coupled to the microcontroller 10 controls the timer operation by following the microcontroller's control. Here, the timer unit 20 may be a simple timer unit or a Real Time Controller (RTC). In addition, the timer unit 20 may further notify the microcontroller 10 to shut down the voltage converter 40 to prevent the 3C electronic product 60 from being overcharged after for example, but not limited to 120 minutes. Wherein, the predetermined time value mentioned above is programmable and can be stored in the microcontroller 10.

The input button 30 coupled to the microcontroller 10 may be a general button protruding from the case (not shown) of the portable electronic device 1, such that the user can press the input button 30 to activate the portable electronic device 1 to charge the 3C electronic product 60.

The voltage converter 40 coupled to the microcontroller 10 and the input button 30 follows the microcontroller's control to activate or deactivate the voltage converter 40. Wherein, the voltage converter 40 is a DC/DC voltage converter which supplies one DC power to the microcontroller 10 and the timer unit 20 and also provides another DC power in order to charge the 3C electronic product 60 through the output interface 50.

The output interface 50 coupled to the output of the voltage converter 40 is for example, but not limited to be a USB interface or an IEEE 1394 interface. In the present embodiment, the output interface 50 is exemplified as a USB interface, but it is not limited by it.

As shown in FIG. 2, when the portable electronic device 1 is being operated, the user first uses a USB cable 65 to connect the 3C electronic product 60 to the output interface 50 of the present invention; then the user presses the input button 30 to activate the voltage converter 40 to output the DC power to the microcontroller 10 and the timer unit 20; then the microcontroller 10 activates the timer unit 20 to count the minutes until the timer unit reaches the predetermined time value and also activates the voltage converter 40 to output the DC power to the output interface 50; afterwards, the DC power is output from the output interface 50 through the USB cable 65 to charge the 3C electronic product 60; finally, when the timer unit 20 reaches the predetermined time value, the timer unit 20 will notify the microcontroller 10 to shut down the DC power output from the voltage converter 40 to prevent the 3C electronic product 60 from being overcharged. The portable electronic device with chargeable circuit 1 of the present invention does not only supply power to charge the 3C electronic product when the system is turned off, but also comprises a timer unit to prevent the 3C electronic product from being overcharged. Therefore, the portable electronic device with chargeable circuit 1 of the present invention is more progressive and innovative in comparison with the conventional technique.

Accordingly, the portable electronic device with chargeable circuit 1 of the present invention is advantageous in its capability of supplying power to charge the external 3C electronic product when the system is turned off and comprising a timer unit to prevent the 3C electronic product from being overcharged, which overcomes the disadvantages of the conventional technique.

Although the invention has been described with reference to a particular embodiment thereof, it will be apparent to one of the ordinary skills in the art that modifications to the described embodiment may be made without departing from the spirit of the invention. Accordingly, the scope of the invention will be defined by the attached claims not by the above detailed description.

What is claimed is:

1. A portable electronic device with chargeable circuit, comprising:
a microcontroller;
a timer unit coupled to said microcontroller;
an input button coupled to said microcontroller;
a voltage converter coupled to said microcontroller and said input button; and
an output interface coupled to an output of said voltage converter;
whereby, when said input button is pressed, said voltage converter is activated to supply power to said microcontroller, such that said microcontroller will activate said timer unit and activate said voltage converter for outputting power to said output interface in order to charge an electronic product.

2. The portable electronic device with chargeable circuit of claim 1, wherein said microcontroller is an Embedded Controller (EC).

3. The portable electronic device with chargeable circuit of claim 1, wherein said timer unit further notifies said microcontroller to shut down said voltage converter after a predetermined time value is reached.

4. The portable electronic device with chargeable circuit of claim 3, wherein said predetermined time value is programmable and can be stored in said microcontroller.

5. The portable electronic device with chargeable circuit of claim 1, wherein said voltage converter is a DC/DC voltage converter.

6. The portable electronic device with chargeable circuit of claim 1, wherein said portable electronic device is a notebook computer.

7. The portable electronic device with chargeable circuit of claim 1, wherein said output interface is a USB interface or an IEEE 1394 interface.

8. The portable electronic device with chargeable circuit of claim 1, wherein said electronic product is a Communications, Consumer Electronics or Computing electronic product.
